(19) United States
(12) Patent Application Publication
(10) Pub. No.: US 2021/0394398 A1
(43) Pub. Date: Dec. 23, 2021

(54) Self-Contained Recycling and Fabrication Appliance

(71) Applicant: Avenues World Holding, LLC, New York, NY (US)

(72) Inventors: William Lidwell, New York, NY (US); Jason Holden, New York, NY (US); Jared Thorn, New York, NY (US); Guilherme Coube, Sao Paulo (BR); Isabella Gomes, Sao Paulo (BR)

(21) Appl. No.: 17/316,887

(22) Filed: May 11, 2021

Related U.S. Application Data
(60) Provisional application No. 63/042,126, filed on Jun. 22, 2020.

(51) Int. Cl. B29B 17/00; B29C 70/48; B33Y 30/00; B29C 64/165

(52) U.S. Cl. CPC B29B 17/0042; B29C 70/48; B29L 2031/102; B33Y 30/00; B29C 64/165; B29B 17/0036

(57) ABSTRACT

A recycling and fabrication appliance is provided. The recycling and fabrication appliance is generally configured to convert solid waste, solid materials and/or solid objects into a usable or reusable product. The recycling and fabrication appliance generally comprises a single unit with one or more inputs and one or more outputs. The unit may be a cuboid, or may be any appropriate shape, and may specifically be configured to recycle or repurpose solid waste, solid materials or solid objects into a reusable form at or near the point of consumption or disposal, such as a household or office. The components of the recycling and fabrication appliance may be housed within the unit and may enable the recycling and fabrication appliance to receive various solid waste pieces as an input and to produce a single usable output, referred to herein as a output object.

### CROSS REFERENCE TO RELATED APPLICATIONS

This application claims priority and benefit to Provisional Patent Application Ser. No. 63/042,126, filed Jun. 22, 2020.

### TECHNICAL FIELD

The field of invention relates generally waste recycling systems, and more specifically, to a self-contained recycling and fabrication appliance and corresponding method.

### BACKGROUND

A common myth is that recycling is effective for most types of solid waste, such as plastics, paper, glass, metals, and the like. In truth, recycling is currently only cost effective and environmentally beneficial for metals such as tin and aluminum and in certain cases, paper. Recycling metals is cost-effective and environmentally beneficial because mining new metals is more expensive and more environmentally detrimental than recycling them.

Recycling paper is sometimes cost-effective and environmentally beneficial when paper is properly separated and uncontaminated, which is often not the case. For most other solid waste materials, the total costs and negative environmental impacts of recycling are greater than those of competing disposal options such as landfill and incineration. Consequently, waste intended for recycling is often sent to landfills and incinerators, or in some cases is illegally dumped on public lands or in the ocean, without the public's awareness or consent.

Consumers are becoming aware of this misdirection, causing an erosion of public trust in corporations and governments to responsibly recycle and dispose of solid waste. Consequently, consumers increasingly desire more control and transparency over the disposal of solid waste. Additionally, there is a wide variety of non-recyclable materials that are not easily distinguishable or separable from recyclable materials, which makes recycling difficult and limited in its ability to deal with a significant percentage of the solid waste generated. Further, contamination makes a significant percentage of otherwise recyclable solid waste unrecyclable. Also, some forms of solid waste such as medicines, batteries, and e-waste are hazardous when landfilled, incinerated, or improperly recycled.

For at least these reasons, there is a need for more cost-effective and environmentally beneficial ways to dispose of and recycle solid waste.

### SUMMARY

A self-contained recycling and fabrication appliance having a user interface for the operation of the appliance, a housing, the user interface mounted to an exterior of the housing, a receptacle unit configured to receive one or more types of solid materials, the receptacle unit configured to transfer the solid materials to a size reduction unit, the size reduction unit configured to receive said solid materials from the receptacle unit, the size reduction unit reducing materials to small particulates or fragments, the size reduction unit transferring the small particulates or fragments to a mixing unit, the mixing unit configured to receive the particulates or fragments from the size reduction unit, the mixing unit mixes the particulates or fragments with a sequestration or binding agent, the sequestration or binding agent sticks to or encases all particulates or fragments, the mixing unit transferring the resulting mixture to a forming unit, and the forming unit configured to receive a mixture from the mixing unit, wherein the forming unit renders the above mixture into at least one output object without the need of auxiliary heat treatment, the housing at least partially enclosing the receptacle unit, the size reduction unit, the mixing unit, and the forming unit so as to form a singular appliance. In some embodiments, the interface provides feedback and input, the interface further controls the interactions between the receptacle unit, the size reduction unit, the mixing unit, and the forming unit, the interface further provides relating to the output object. In some embodiments, the solid material is directed to the size reduction unit by means of gravity, release of a trap door, and/or a pusher. In some embodiments, the system processes solid materials using a single universal comminution device. In some embodiments, the size reduction unit processes solid materials using at least one mechanism to facilitate crushing, shredding, and/or grinding. In some embodiments, the appliance uses at least one sensor and feedback therefrom to separate the solid materials in accordance with their individual material properties. In some embodiments, the mixing unit is integrated with the forming unit to mix and form the specified object in the same chamber. Further, a method is provided including the steps of curing a hard outer shell, filling the hard outer shell with the input materials combined with the sequestration or binding agent, and curing this filler material. In some embodiments, the mixing unit uses nozzles, sprays, stirring components, and/or flow mechanisms to mix the particulates or fragments with sequestration or binding agent. In some embodiments, the sequestration or binding agent is cured via UV light or catalyst. In some embodiments, a single mold is selected from a plurality of molds to form the output object. In other embodiments, the forming unit uses 3D printing mechanisms to print the output object.

A self-contained recycling and fabrication appliance is provided having a user interface for the operation of the appliance, a housing, the user interface mounted to an exterior of the housing, a solid object input unit configured to receive at least one type of solid object, the solid objects being hazardous, non-recyclable or difficult to dispose of, the solid object input until configured to transfer a solid object to an encasing unit, the encasing unit configured to receive the at least one solid object, the encasing unit fully encases the solid object with an impermeable sequestration or binding agent and renders the combination into one or more specified objects without the need for auxiliary heat, and the housing at least partially enclosing the solid object input unit and the encasing unit so as to form a stand-alone appliance. In some embodiments, the sequestration or binding agent is cured via UV light or other catalyst. In some embodiments, a single mold is selected from a plurality of molds to form the output object. In some embodiments, one or more of the specified objects are bricks for use in construction. In some embodiments, the appliance is also configured to receive solid materials. In some embodiments, a sensor is provided, the sensor configured to distinguish between solid materials and solid objects. In some embodiments, the appliance includes a means to separate the solid materials from the solid objects for solid object encapsulation.

A self-contained recycling and fabrication appliance having a housing, a receptacle unit configured to receive one or more types of solid materials, the receptacle unit configured to transfer the solid materials to a size reduction unit, and the size reduction unit configured to receive materials from the receptacle unit, the size reduction unit reducing materials to small particulates or fragments, the size reduction unit transferring the small particulates or fragments to a mixing unit, a solid object input unit configured to receive at least one type of solid object, the solid object input unit accessible by means of a second opening in the housing, the solid objects being hazardous, non-recyclable or difficult to dispose of, the solid object input until configured to transfer a solid object to an encasing unit using processed material from the receptacle unit.

### BRIEF DESCRIPTION OF THE DRAWINGS

The operation of the invention may be better understood by reference to the detailed description taken in connection with the following illustrations, wherein:

FIG. 1 illustrates an exploded perspective view of a self-contained recycling and fabrication appliance configured to receive materials, including but not limited to plastics, paper, glass, wood, or soft metals; and objects such as batteries, cell phones, and expired medicines in accordance with one or more embodiments as shown or described herein;

FIG. 2 illustrates an assembled perspective view of a self-contained recycling and fabrication appliance configured to receive materials, including but not limited to plastics, paper, glass, wood, or soft metals; and objects such as batteries, cell phones, and expired medicines in accordance with one or more embodiments as shown or described herein;

FIG. 3 illustrates a flowchart of a recycling and fabrication appliance process for materials, including but not limited to plastics, paper, glass, wood, or soft metals in accordance with one or more embodiments as shown or described herein;

FIG. 4 illustrates a flowchart of a recycling and fabrication appliance process for objects such as batteries, cell phones, and expired medicines in accordance with one or more embodiments as shown or described herein;

FIG. 5 illustrates an exploded perspective view of a self-contained recycling and fabrication appliance configured to receive materials, including but not limited to plastics, paper, glass, wood, or soft metals including a three-dimensional printing option in accordance with one or more embodiments as shown or described herein;

FIG. 6 illustrates an assembled perspective view of a self-contained recycling and fabrication appliance configured to receive materials, including but not limited to plastics, paper, glass, wood, or soft metals including a three-dimensional printing option in accordance with one or more embodiments as shown or described herein;

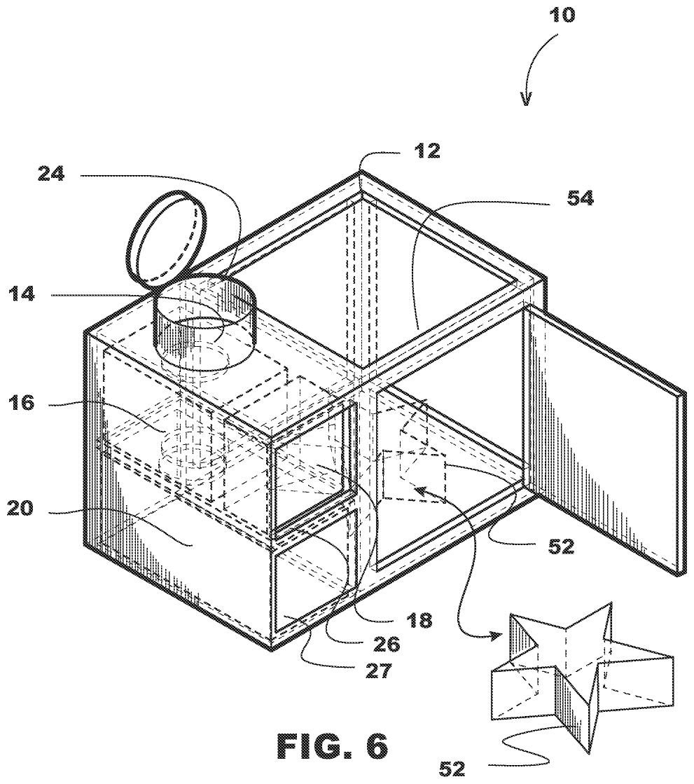

FIG. 7 illustrates an exploded perspective view of a recycling and fabrication appliance for objects such as batteries, cell phones, and expired medicines in accordance with one or more embodiments as shown or described herein; and

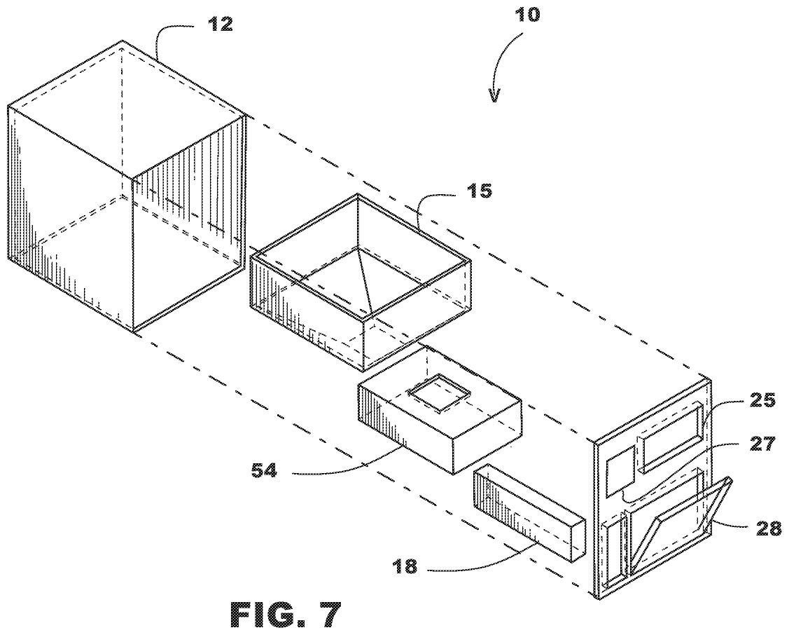

FIG. 8 illustrates an assembled perspective view of a recycling and fabrication appliance for objects such as batteries, cell phones, and expired medicines in accordance with one or more embodiments as shown or described herein.

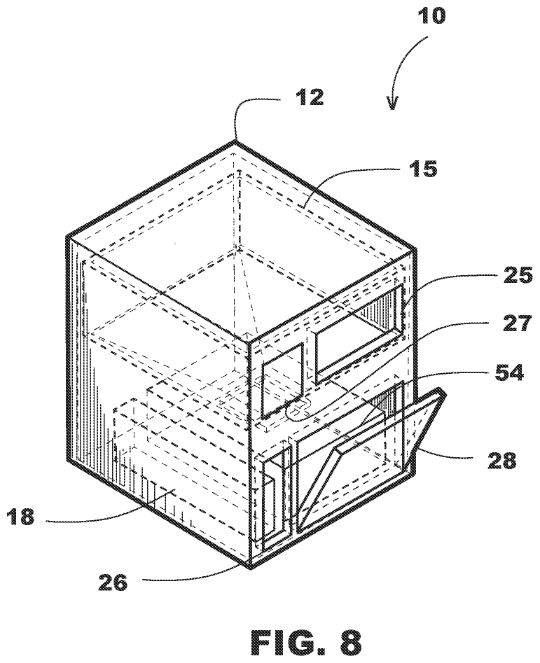

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

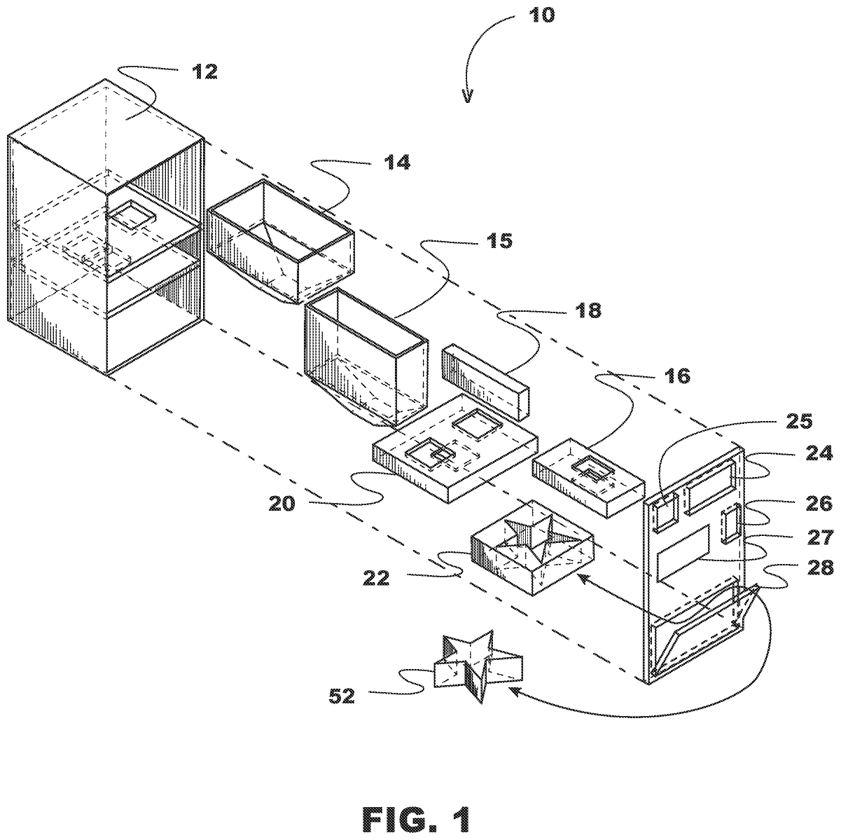

With reference to FIGS. 1-5, a recycling and fabrication appliance 10 is generally presented. The recycling and fabrication appliance 10 is generally configured to convert solid waste or solid materials into a usable or reusable product. For purposes of this specification, “solid waste” and “solid materials” are used interchangeably and are defined as materials other than liquids including, but not limited to, traditionally recyclable and non-recyclable materials including but not limited to plastics or polymers, paper, glass, cardboard, Styrofoam® (or any closed-cell extruded polystyrene foam or other solid foam), fabrics, rubbers, wood and metals, in any ratio, and may include common contaminants such as food residue. Exceptions may include soft food or organic waste, liquids, dense metals, pressurized containers, and hazardous waste.

The recycling and fabrication appliance 10 may generally comprise a single unit with one or more inputs and one or more outputs. The unit may be a cuboid, as illustrated, or may be any appropriate shape, and may specifically be configured to recycle solid waste into a reusable form at or near the point of consumption or disposal, such as a household or office. It should be understood that “appliance” as defined herein is a device or piece of equipment designed to perform a specific task, typically a domestic one, and not a large-scale operation (e.g. a factory or mass processing facility). An “appliance” as defined herein is intended for small scale use only in a house, community, community resource center, office space or other similarity sized small unit. The components of the recycling and fabrication appliance 10, as described herein, may be housed within the unit and may enable the recycling and fabrication appliance 10 to receive various solid waste pieces as an input and to produce a single usable output, referred to herein as a recycled product 52.

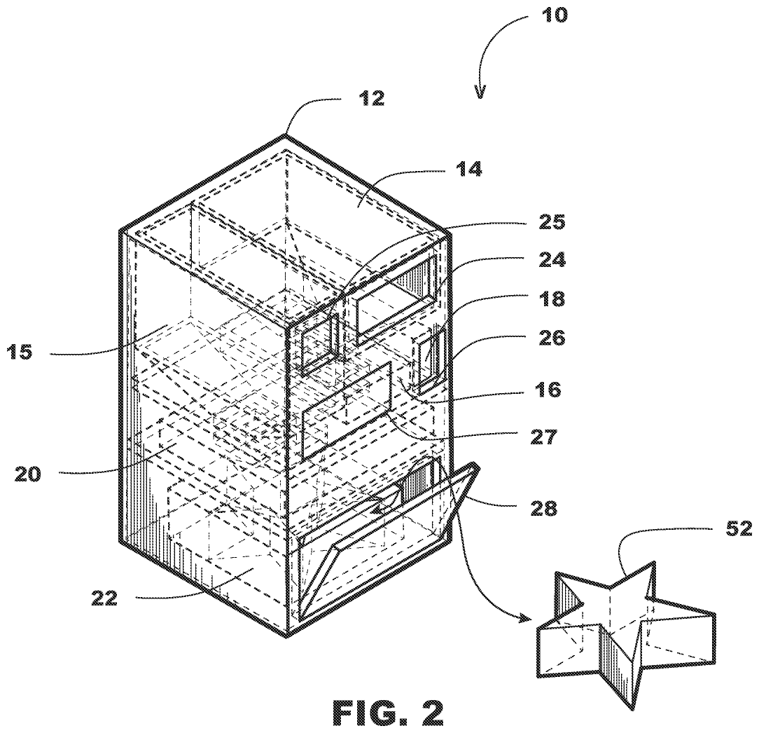

With reference to the exploded view of FIG. 1 and the assembled view of FIG. 2, the various components of the recycling and fabrication appliance 10 are illustrated. These components include a housing 12, a waste receptacle 14, a size reduction unit 16, a reservoir 18, a mixing unit 20, and a mold 22. The housing 12 may further include a waste input 24, a reservoir input 26, and an output opening 28. The function of each component and interplay between components is described in further detail below. It will be appreciated that variations or embodiments of the invention described herein may omit components from the system or add new components to the recycling and fabrication appliance 10.

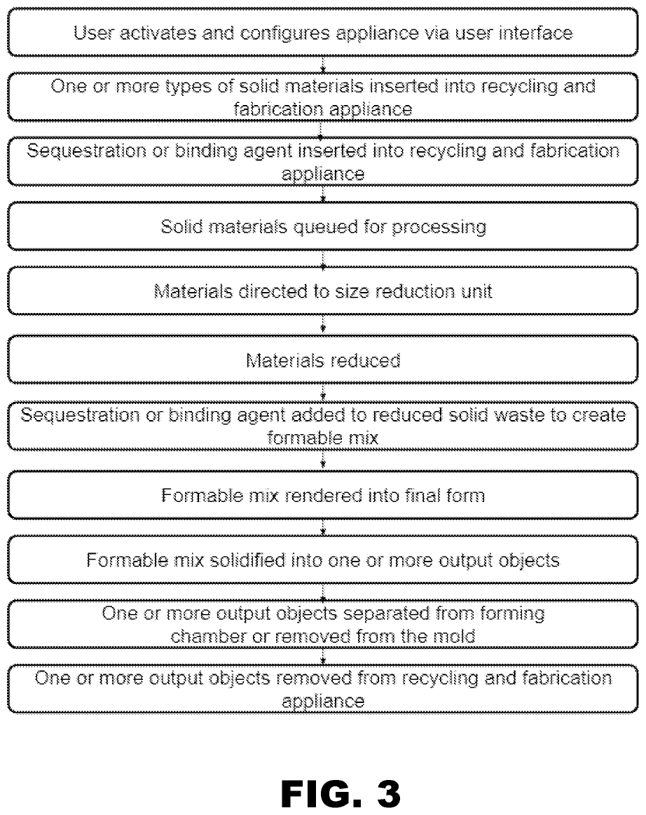

The operation and functionality of the recycling and fabrication appliance 10 is generally described in the flowchart of FIG. 3. It will be appreciated that the steps illustrated in the flowchart and described below may be performed out of order or the order of steps rearranged without departing from the embodiments of the invention. The operations as described herein may be performed manually or in an automated manner. For automated functionality, the recycling and fabrication appliance 10 may include a user interface 27 and various sensors that function as inputs to a central processor or computer that controls operations of the system, and may include control outputs, such as motors, gears, cylinders, valves, and the like, to move components of the system and enable processing of the solid waste.

In a first step 30, solid waste may be input into the recycling and fabrication appliance 10. The solid waste may comprise any type of solid waste, or may be limited to only receiving certain types of solid waste. For example, the recycling and fabrication appliance 10 may be limited to processing non-metallic waste or may exclude certain types of metal waste, such as aluminum or tin. The solid waste may be inserted through the waste input 24. The waste input 24 may generally comprise an opening in the housing 12, such as in the front of the housing 12, that is sized and shaped to allow large portions of solid waste to be inserted therethrough. The waste input 24 may optionally include a door to close off the opening when solid waste is not being inserted. The inserted solid waste may be held in the waste receptacle 14. The waste receptacle 14 may generally comprise a bin that is supported by the housing 12 and positioned at or below the waste input 24. The waste receptacle 14 may include a tapered bottom surface to funnel solid waste to other components of the recycling and fabrication appliance 10, such as the size reduction unit 16.

In a second step 32, a binder may be inserted into the recycling and fabrication appliance 10, such as through the reservoir input 26. The binder, also sometimes referred to as a sequestration matrix, may generally comprise a liquid or powder that is configured to bind portions of the solid waste together. The binder may comprise an adhesive material, or any material that may be used to bind together the portions of solid waste inserted into the recycling and fabrication appliance 10. The binder may be held within the reservoir 18 until it is needed for dispensing and mixing with the solid waste, as described below. It will be appreciated that the second step 32 of adding the binder into the recycling and fabrication appliance 10 may be performed before the first step 30 of adding solid waste into the recycling and fabrication appliance 10.

In a third step 34 the solid waste may be queued for processing. In an embodiment, the solid waste may be held within the waste receptacle 14 until the recycling and fabrication appliance 10 determines that the solid waste is ready to be processed. The recycling and fabrication appliance 10 may accumulate solid waste within the waste receptacle 14 until a predetermined mass or volume of solid waste has been accumulated within the waste receptacle 14 or until a predetermined time limit is reached, before initiating processing of the solid waste. Alternatively, in an embodiment, the solid waste that is inserted into the recycling and fabrication appliance 10 may be immediately processed after input.

In a fourth step 36, once the recycling and fabrication appliance 10 initiates processing of the solid waste, the solid waste may be moved to the size reduction unit 16. The solid waste may be moved using any appropriate means, such as gravity and release of a trap door, a pusher, or any other type of mechanically moved gears or elements to displace the solid waste from the waste receptacle 14 to the size reduction unit 16.

In another embodiment, step 34 in the flowchart may include differentiation between common solid materials and potentially hazardous objects such as batteries, cell phones, expired medicines, or any other object deemed potentially hazardous or not recyclable (herein defined as “solid object(s)” noting that solid objects and hazardous object may be used interchangeably). The hazardous or solid objections is a subset of solid waste that is hazardous to dispose of in a landfill or grind into particulates, including e-waste such as batteries or cellphones, and solid biological waste such as medicines. These solid objects may be identified by the user or through sensors that function as inputs to a central processor. The objects may then be separated from common solid materials through a separate solid objects input 25 or through mechanical means, such as motors, gears, cylinders, valves, and the like. These objects may be directed to a solid objects receptacle 15 and may then bypass steps 36 and 38 and the size reduction unit 16 and go directly to the mixing unit 20 or forming chamber 54.

In a fifth step 38, the solid waste within the size reduction unit 16 is reduced. The reduction may comprise compression or compaction implemented by a mechanical compactor. In an embodiment, the size reduction unit 16 may include blades, such as rotary blades, to grind, shred, and/or crush the solid waste into smaller pieces. It will be appreciated that the size reduction unit 16 may include both cutting/shredding and compacting components to perform both operations on the solid waste. The size reduction unit 16 may further include any number of other mechanical components to reduce the size of the inserted solid waste.

In an embodiment, the recycling and fabrication appliance 10 may combine the waste receptacle 14 and the size reduction unit 16 into a single component. This may allow solid waste to be queued within the waste receptacle 14 until processing begins, and then for size reduction operations, as described above, to be performed within the waste receptacle 14.

In a sixth step 40, the final form for the recycled product 52 may be selected. This selection may comprise a mold 22 to be used or inserted into the recycling and fabrication appliance 10, or a selection of a three-dimensional printing output shape, as described in further detail below. While the final form illustrated in FIGS. 1-2 and 4-5 is shown as a star, it will be appreciated that the mold may comprise a brick shape or any other shape to provide functional and/or decorative use.

In an embodiment the recycling and fabrication appliance 10 may include a plurality of molds 22. In one embodiment, the molds 22 may be stored within the recycling and fabrication appliance 10 and selected before or during waste processing. In another embodiment, the molds 22 may be stored external to the recycling and fabrication appliance 10 and may be inserted by a user into the recycling and fabrication appliance 10, such as through the output opening 28. Further, the recycling and fabrication appliance 10 may be configured to receive custom molds formed by a user to yield a custom shaped recycled product 52. It will be appreciated that the mold 22 may be selected prior to or during waste processing.

In a seventh step 42, the reduced solid waste is moved to the mixing unit 20 and combined with the binder. The system may include nozzles, sprays, or other flow mechanisms to distribute the binder within the solid waste. The binder may be stirred into the reduced solid waste, such as mechanically using a rotational stirring component, to evenly distribute the binder throughout the reduced solid waste. The binder acts to adhere the pieces of reduced solid waste together. The binder may assist in making the reduced solid waste into a formable mix or slurry. The formable mix or slurry may also include the whole objects that previously bypassed waste reduction.

In an eighth step 44, the formable mix or slurry may be rendered into final form. In an embodiment that utilizes a mold 22, the formable mix may be set into the mold 22. For example, the formable mix may be liquid enough to be poured into the mold 22 from the mixing unit 20. In another embodiment, the formable mix may be pressed or compressed into the mold 22. In either embodiment, the formable mix may optionally be poured or compressed into the mold in successive layers.

In a ninth step 46 the formable mix (reduced solid waste and binder) is solidified. In an embodiment that utilizes a mold 22, the formable mix may be activated or cured within the mold 22. The activation or curing process may work to harden the formable mix into a single solid piece. The curing process may or may not include active heating, applying UV light, or adding any other materials to the formable mix to induce hardening. The formable mix may be cured as a single unit or may be cured in phases as successive layers of the formable mix are applied to the mold 22. In an embodiment, the formable mix may be externally cured while allowing the internal mixture to remain uncured. For example, the formable mix may be cured to form a hardened outer shell, which may be filled with the input materials combined with the sequestration agent. Then, the filler material may be optionally cured.

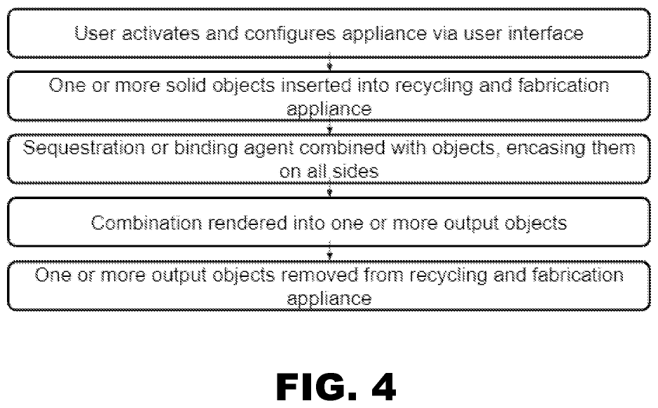

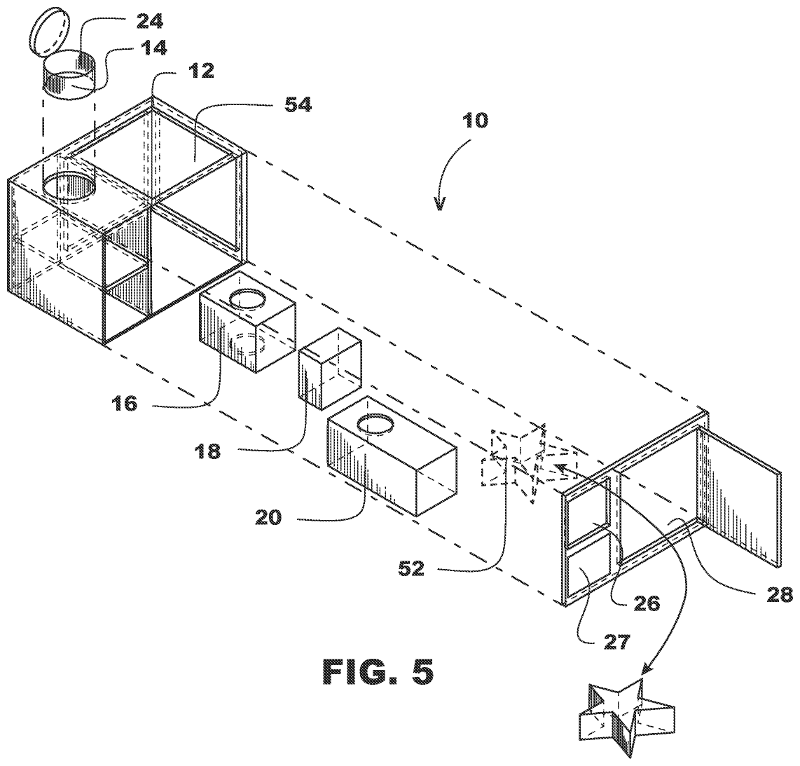

In an embodiment illustrated in FIGS. 4 and 5, the molding process may be replaced or supplemented by a 3D printing process. The recycling and fabrication appliance 10 may be designed and configured to include 3D printing capabilities. For example, the system may include nozzles or other material dispensing tools that are automated to receive the formable mix and to print or form a desired shape out of the formable mix. The printed formable mix may then be cured and hardened. In another example, the printing method might include selectively dispensing a binder onto reduced solid waste material while curing successive layers. In another example, the formable mix is selectively cured using light, laser, or another medium. The examples provided do not limit or exclude the possibility of adding other 3D printing processes to the recycling and fabrication appliance 10. It will be appreciated that the 3D printing processes described herein may perform numerous steps of the process illustrated in FIG. 3, including the form selection 40, rendering the formable mix into final form 44, and solidifying the formable mix and binder 46.

The recycling and fabrication appliance 10 may include a forming chamber 54 to house the 3D printing components and facilitate printing of the recycled product 52. The forming chamber 54 may be positioned adjacent to the other components of the recycling and fabrication appliance 10. In another embodiment, the recycling and fabrication appliance 10 may combine the mixing unit 20 and the forming chamber 54 into a single component. The forming chamber 54 may house nozzles, pumps, lasers, and other mechanisms to facilitate creation and printing of the recycled product 52, and may further include heaters, lights, or other components used to cure the printed recycled product 52.

In a tenth step 48 the recycled product 52 may be separated from the forming chamber or removed from the mold 22. The recycled product 52 may be removed manually by a user, such as after the mold 22 has been removed from the housing 12, or may be automatically removed, such as pushed or ejected out of the mold 22 by mechanical means. Once the recycled product 52 is removed from the mold 22, it may be removed from the housing 12, such as presented out of the output opening 28 or removed through the output opening 28 by a user.

In an eleventh step 50, the recycled product 52 may be reused for alternative purposes. For example, the recycled product 52 may be used as a structural component, such as a brick or support block. Alternatively, the recycled product 52 may be further broken down or recycled using other recycling processes, such as re-introduced as solid waste into a recycling and fabrication appliance 10.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. A self-contained recycling and fabrication appliance comprising:
a user interface for the operation of the appliance;
a housing, the user interface mounted to an exterior of the housing;
a receptacle unit configured to receive one or more types of solid materials, the receptacle unit configured to transfer the solid materials to a size reduction unit;
the size reduction unit configured to receive said solid materials from the receptacle unit, the size reduction unit reducing materials to small particulates or fragments, the size reduction unit transferring the small particulates or fragments to a mixing unit;
the mixing unit configured to receive the particulates or fragments from the size reduction unit, the mixing unit mixes the particulates or fragments with a sequestration or binding agent, the sequestration or binding agent sticks to or encases all particulates or fragments, the mixing unit transferring the resulting mixture to a forming unit; and
the forming unit configured to receive a mixture from the mixing unit, wherein the forming unit renders the above mixture into at least one output object without the need of auxiliary heat treatment, the housing at least partially enclosing the receptacle unit, the size reduction unit, the mixing unit, and the forming unit so as to form a singular appliance.

2. The appliance of claim 1, wherein the interface provides feedback and input, the interface further controls the interactions between the receptacle unit, the size reduction unit, the mixing unit, and the forming unit, the interface further provides relating to the output object.

3. The appliance of claim 1 wherein the solid material is directed to the size reduction unit by means of gravity, release of a trap door, and/or a pusher.

4. The appliance of claim 1, wherein the system processes solid materials using a single universal comminution device.

5. The appliance of claim 1, wherein the size reduction unit processes solid materials using at least one mechanism to facilitate crushing, shredding, and/or grinding.

6. The appliance of claim 1, wherein the appliance uses at least one sensor and feedback therefrom to separate the solid materials in accordance with their individual material properties.

7. The appliance of claim 1, wherein the mixing unit is integrated with the forming unit to mix and form the specified object in the same chamber.

8. A method using the appliance of claim 1 comprising the steps of:
curing a hard outer shell;
filling the hard outer shell with the input materials combined with the sequestration or binding agent; and
curing this filler material.

9. The appliance of claim 1 wherein the mixing unit uses nozzles, sprays, stirring components, and/or flow mechanisms to mix the particulates or fragments with sequestration or binding agent.

10. The appliance of claim 1, wherein the sequestration or binding agent is cured via UV light or catalyst.

11. The appliance of claim 1, wherein a single mold is selected from a plurality of molds to form the output object.

12. The appliance of claim 1, wherein the forming unit uses 3D printing mechanisms to print the output object.

13. A self-contained recycling and fabrication appliance comprising:
a user interface for the operation of the appliance;
a housing, the user interface mounted to an exterior of the housing;
a solid object input unit configured to receive at least one type of solid object, the solid objects being hazardous, non-recyclable or difficult to dispose of, the solid object input until configured to transfer a solid object to an encasing unit;
the encasing unit configured to receive the at least one solid object, the encasing unit fully encases the solid object with an impermeable sequestration or binding agent and renders the combination into one or more specified objects without the need for auxiliary heat; and
the housing at least partially enclosing the solid object input unit and the encasing unit so as to form a stand-alone appliance.

14. The appliance of claim 13, wherein the sequestration or binding agent is cured via UV light or other catalyst.

15. The appliance of claim 13, wherein a single mold is selected from a plurality of molds to form the output object.

16. The appliance of claim 13, wherein one or more of the specified objects are bricks for use in construction.

17. The appliance of claim 13, wherein the appliance is also configured to receive solid materials.

18. The appliance of claim 17 wherein a sensor is provided, the sensor configured to distinguish between solid materials and solid objects.

19. The appliance of claim 18, wherein the appliance includes a means to separate the solid materials from the solid objects for solid object encapsulation.

20. A self-contained recycling and fabrication appliance comprising:
a housing;
a receptacle unit configured to receive one or more types of solid materials, the receptacle unit configured to transfer the solid materials to a size reduction unit; and
the size reduction unit configured to receive materials from the receptacle unit, the size reduction unit reducing materials to small particulates or fragments, the size reduction unit transferring the small particulates or fragments to a mixing unit;
a solid object input unit configured to receive at least one type of solid object, the solid object input unit accessible by means of a second opening in the housing, the solid objects being hazardous, non-recyclable or difficult to dispose of, the solid object input until configured to transfer a solid object to an encasing unit using processed material from the receptacle unit.
